(19) United States
(12) Patent Application Publication
(10) Pub. No.: US 2022/0121136 A1
(43) Pub. Date: Apr. 21, 2022

(54) IMAGE FORMING APPARATUS

(71) Applicant: Konica Minolta, Inc., Tokyo (JP)

(72) Inventors: Wataru WATANABE, Tokyo (JP); Shunichi TAKAYA, Tokyo (JP); Hokuto HATANO, Toyohashi-shi (JP)

(21) Appl. No.: 17/483,695

(22) Filed: Sep. 23, 2021

(30) Foreign Application Priority Data
Oct. 19, 2020 (JP) 2020-175060

(51) Int. Cl. G03G 15/02; G03G 15/08

(52) U.S. Cl. CPC G03G 15/0266; G03G 15/0806; G03G 15/0849

(57) ABSTRACT

An image forming apparatus includes an image carrier; an exposure device which draws an electrostatic latent image on the image carrier; a developer which uses a developing roller facing the image carrier to supply a developing agent to the electrostatic latent image formed on the image carrier and to develop a toner image; a developing current detector which detects a developing current flowing between the image carrier and the developing roller during developing by the developer; and a controller which controls the above. The controller performs forced toner discharge control in which a predetermined toner image is developed on the image carrier by the developer and the toner is forcibly discharged from the developer. The controller controls a toner discharge amount in the forced toner discharge control based on a current value detected by the developing current detector.

### CROSS-REFERENCE TO RELATED APPLICATIONS

The entire disclosure of Japanese Patent Application No. 2020-175060 filed on Oct. 19, 2020 is incorporated herein by reference in its entirety.

### BACKGROUND

### Technological Field

The present invention relates to an image forming apparatus.

### Description of the Related Art

Generally, an electrophotographic-type image forming apparatus performs an image forming process. In the image forming process, light is exposed on a charged photoconductor in accordance with image information to draw an electrostatic latent image, toner is supplied to the electrostatic latent image from a developer, and the toner image is formed on the photoconductor. The toner image is transferred on the recording medium and fixed.

In such electrophotographic-type image forming apparatus, after printing a large amount of low-coverage images, the external additive on the surface of the toner in the developer may be buried or released. With this, deteriorated toner in which the expected charging performance cannot be achieved increases. This may cause problems such as overlapping, scattering of toner, rough halftone images, and the like.

The toner which received stress may be aggregated in a toner replenishment device or a developer, and become deteriorated toner. This may cause problems such as toner spill or dots in the halftone image.

It is difficult to return deteriorated toner to normal toner. Therefore, when the apparatus detects that the deteriorated toner is increasing, or the operator notices the problems, toner refresh control is performed. In the toner refresh control, a toner image with the surface colored solid is made with toner including the deteriorated toner and the deteriorated toner is discharged from the developer to the photoreceptor. Then, fresh toner is replenished, and the toner in the developer is replaced.

Such solid coloring of the surface performed according to toner refresh control should be performed in a square area so that all of the deteriorated toner which should be replaced is discharged.

However, it is difficult to detect the remaining amount and the discharged amount of the deteriorated toner. Therefore, normally, the square area of the solid colored surface to be created is determined in advance, and when the operator determines that there is deteriorated toner remaining after performing the toner refresh control, the toner refresh control is performed repeatedly until the operator determines that there is no more deteriorated toner.

Therefore, the process until improvement is obtained may not be efficient, and it is not possible to automatically perform the control without the operator. The square area of the solid colored surface to be created may be made larger so that the deteriorated toner is discharged sufficiently from the developer. However, unnecessary discharge may be performed. Moreover, the discharge operation may continue even when the toner concentration is decreased to the limit. Therefore, in view of the above situation, the above process is not employed.

In the technique described in JP 2005-189790, the charge amount of the developing agent in the apparatus is measured using the developing current and the IDC sensor. According to the result, at least one among the charge potential, the exposure potential, the developing bias, the toner replenishment amount and the transfer bias is adjusted. With this, the image concentration is stable, stains in the background, toner scattering and carrier adhesion are suppressed, and a high transfer rate is maintained regardless of change in the environment and durability. Especially when the charge amount does not recover even after adjusting the toner replenishment amount, the margin voltage is reduced to discharge the deteriorated toner on the photoreceptor, and fresh toner is replenished.

In the technique described in JP 2006-243114, the charge amount of the developing agent in the apparatus is measured using a potential sensor and an IDC sensor. According to the result, the forced discharge amount of the toner (coverage of the discharged image) is determined, and the toner is discharged on the photoreceptor. Then, the toner is replenished based on the output from a TCR sensor.

### SUMMARY

However, according to the conventional technique, the remaining amount of toner and the discharge amount of toner cannot be detected while control is performed to forcibly discharge deteriorated toner. Therefore, it is not possible to accurately control the discharge amount of toner.

The present invention is made in view of the above problems of the conventional technique, and the purpose of the present invention is to accurately control the discharge amount of the toner when the deteriorated toner is discharged forcibly from the developer of the image forming apparatus.

To achieve at least one of the abovementioned objects, according to an aspect of the present invention, an image forming apparatus reflecting one aspect of the present invention is shown, the apparatus including an image carrier; an exposure device which draws an electrostatic latent image on the image carrier; a developer which uses a developing roller facing the image carrier to supply a developing agent to the electrostatic latent image formed on the image carrier and to develop a toner image; a developing current detector which detects a developing current flowing between the image carrier and the developing roller during developing by the developer; and a controller which controls the above, wherein, the controller performs forced toner discharge control in which a predetermined toner image is developed on the image carrier by the developer and the toner is forcibly discharged from the developer, and the controller controls a toner discharge amount in the forced toner discharge control based on a current value detected by the developing current detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram schematically showing an entire configuration of an image forming apparatus;

FIG. 2 is a block diagram showing a functional configuration of the image forming apparatus;

FIG. 3 is a cross-sectional view showing a schematic configuration of a developer;

FIG. 4 is a graph showing a change in a developing current value detected by a developing current detector with relation to an elapsed time of developing of a solid colored surface according to a present invention example 1;

FIG. 5 is a graph showing a change in the developing current value detected by the developing current detector with relation to the elapsed time of developing of the solid colored surface according to a present invention example 2;

FIG. 6 is a graph showing a change in the developing current value detected by the developing current detector with relation to the elapsed time of developing of the solid colored surface according to a present invention example 3;

FIG. 7 is a graph showing a change in the developing current value detected by the developing current detector with relation to the elapsed time of developing of the solid colored surface according to a present invention example 4; and

FIG. 8 is a graph showing a change in the developing current value detected by the developing current detector with relation to the elapsed time of developing of the solid colored surface according to a present invention example 5.

### DETAILED DESCRIPTION OF THE EMBODIMENTS

Hereinafter, one or more embodiments of the present invention will be described with reference to the drawings. However, the scope of the present invention is not limited to the disclosed embodiments.

Hereinafter, embodiments of the present invention are described with reference to the drawings. The following is an embodiment of the present invention and does not limit the present invention.

[Configuration of Image Forming Apparatus]

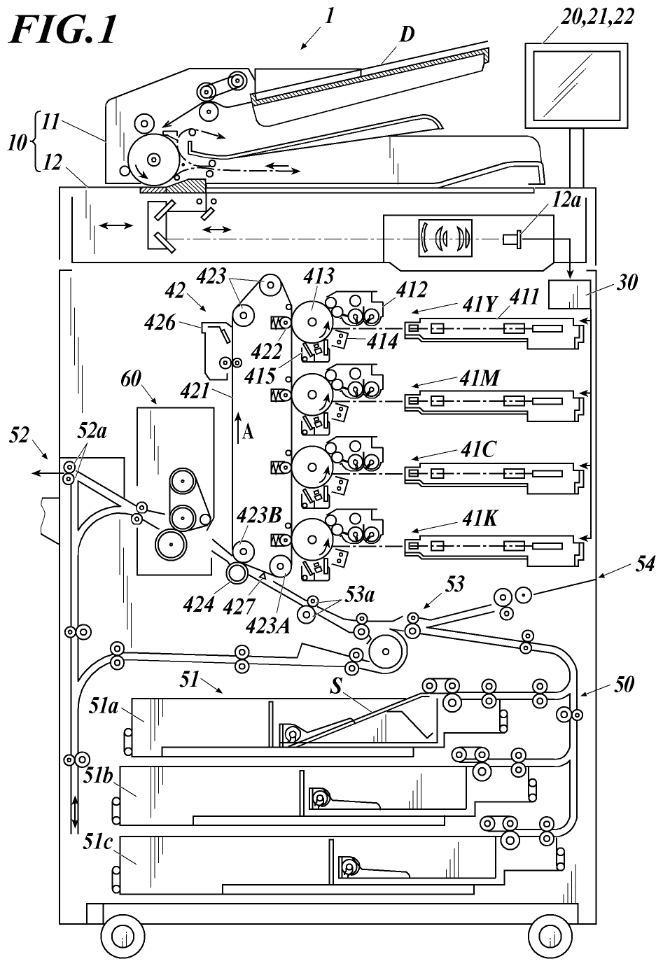

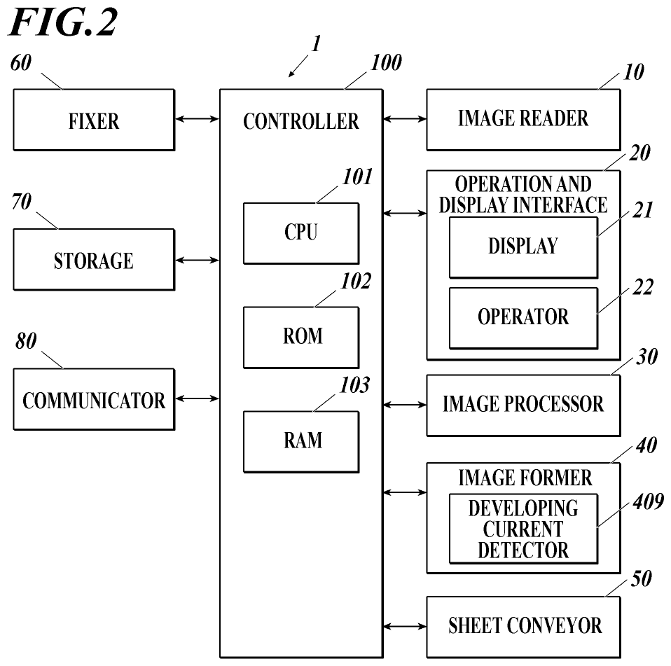

FIG. 1 is a diagram schematically showing an entire configuration of an image forming apparatus 1 according to the present embodiment. FIG. 2 is a block diagram showing a configuration of the main function of the image forming apparatus 1 according to the present embodiment.

The image forming apparatus 1 shown in FIG. 1 and FIG. 2 is an intermediate transfer type color image forming apparatus using an electrophotographic process technique. That is, the image forming apparatus 1 transfers toner images in each color including Y (yellow), M (magenta). C (cyan), and K (black) formed on a photosensitive drum 413 onto an intermediate transfer belt 421 (primary transfer). After overlapping the toner images of the four colors on the intermediate transfer belt 421, the overlapped image is transferred onto a sheet (secondary transfer). With this, an image is formed.

The image forming apparatus 1 employs a tandem method. According to the tandem method, photosensitive drums 413 corresponding to the four colors of YMCK are positioned in a series in a traveling direction of the intermediate transfer belt 421. The toner images in each color are sequentially transferred onto the intermediate transfer belt 421.

As shown in FIG. 2, the image forming apparatus 1 includes an image reader 10, an operation and display interface 20, an image processor 30, an image former 40, a sheet conveyer 50, a fixer 60, a storage 70, a communicator 80, and a controller (hardware processor) 100.

The controller 100 includes a CPU (Central Processing Unit) 101, a ROM (Read Only Memory) 102, a RAM (Random Access Memory) 103, and the like. The CPU 101 reads a program from the ROM 102 according to contents of processing and deploys the program in the RAM 103. In coordination with the deployed program, the image forming apparatus 1 centrally controls the operation of each block in the image forming apparatus 1 shown in FIG. 2.

The image reader 10 includes an automatic document feeding apparatus 11 called an ADF (Auto Document Feeder), a document image scanning apparatus 12 (scanner), and the like.

The automatic document feeding apparatus 11 conveys the document D placed on the document tray by a conveyance mechanism and sends the document D to the document image scanning apparatus 12. The automatic document feeding apparatus 11 is able to continuously read at once images (including both surfaces) of the document D consisting of a plurality of number of sheets placed on the document tray.

The document image scanning apparatus 12 optically scans the document conveyed on the contact glass from the automatic document feeding apparatus 11 or the document placed on the contact glass. An image is formed on a light receiving surface of a CCD (Charge Coupled Device) sensor 12a from the light reflected on the document and the document image is read.

The image reader 10 generates input image data based on a result read by the document image scanning apparatus 12. A predetermined image process is performed on the input image data by the image processor 30.

The operation and display interface 20 includes a liquid crystal display (LCD) with a touch panel, and functions as a display 21 and an operator 22. The display 21 displays various operation screens, state of the image, and state of operation of the various functions according to a display control signal input from the controller 100. The operator 22 includes various operation keys such as numeric keys and a start key. The operator 22 receives various input operation by the user and outputs the operation signal to the controller 100.

The image processor 30 includes a circuit to perform digital image processes on input image data of a job according to an initial setting or a user setting. For example, under the control of the controller 100, the image processor 30 performs gradation correction based on gradation correction data (gradation correction table). In addition to the gradation correction, the image processor 30 performs various correction processes such as color correction, shading correction, etc., and a compression process on the input image data. The image former 40 is controlled based on the image data subjected to the above processes.

The image former 40 includes image forming units 41Y, 41M, 41C, and 41K to form an image with each color toner including Y component, M component, C component, and K component based on the input image data in which the image processing is performed, an intermediate transfer unit 42, and the like.

The image forming units 41Y, 41M, 41C, and 41K for Y component, M component, C component, and K component include a similar configuration. For convenience of illustration and description, common components are indicated by the same reference numerals, and each color is distinguished by adding Y, M. C, or K to the reference numerals. In FIG. 1, the reference numerals are shown for only the components of an image forming unit 41Y for the Y components. The reference numerals for the components of the other image forming units 41M, 41C, and 41K are omitted.

The image forming unit 41 includes an exposure device 411, a developer 412, a photosensitive drum 413 (image carrier), a charging device 414, a drum cleaning device 415, and the like.

The photosensitive drum 413 is a negative charge type organic photoconductor (OPC) in which an under coat layer (UCL), a charge generation layer (CGL), and a charge transport layer (CTL) are layered sequentially on a peripheral surface of a conductive cylinder (aluminum base tube) made of aluminum, for example.

The charge generation layer includes an organic semiconductor in which a charge generation material (for example, phthalocyanine pigment) is dispersed in a resin binder (for example, polycarbonate). When exposed by the exposure device 411, a pair of positive charge and negative charge is generated.

The charge transport layer includes a hole transport material (electron donating nitrogen-containing compound) dispersed on a resin binder (for example, polycarbonate resin). The positive charge generated in the charge generation layer is transported to the surface of the charge transport layer.

The controller 100 controls driving currents supplied to a driving motor (not illustrated) which rotates the photosensitive drum 413 to rotate the photosensitive drum 413 at a constant peripheral speed (for example, 665 mm/s).

The charging device 414 uniformly charges the surface of the photosensitive drum 413 including photoconductive properties to the negative polarity. The exposure device 411 includes a semiconductor laser, for example, and irradiates a laser beam corresponding to the image of each color component to the photosensitive drum 413. A positive charge is generated in the charge generation layer of the photosensitive drum 413. The positive charge is transported to the surface of the charge transport layer. With this, the charge of the surface of the photosensitive drum 413 (negative charge) is neutralized. An electrostatic latent image of each color component is formed on the surface of the photosensitive drum 413 by the potential difference from the surroundings.

The developer 412 is a two-component developing type developer using a two component developing agent including a toner and a carrier. The toner of each color component is attached to the surface of the photosensitive drum 413. With this, the electrostatic latent image is visualized, and the toner image is formed.

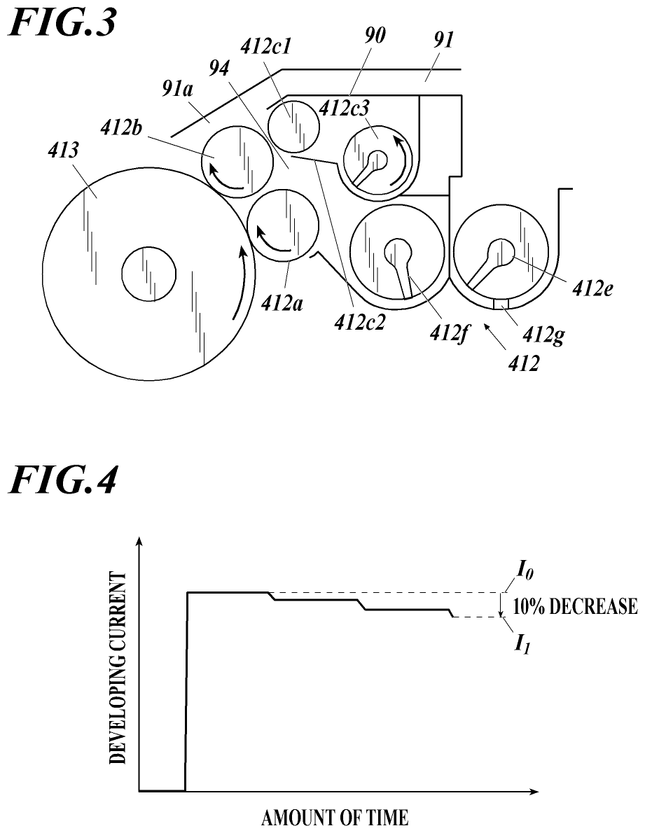

Hereinafter, the configuration of the developer 412 is described in detail with reference to FIG. 3.

The developer 412 is an apparatus to form the toner image by attaching the toner of each color component on the surface of the photosensitive drum 413. As shown in FIG. 3, the developer 412 includes a first developing roller 412a, a second developing roller 412b, a collecting roller 412c1, a mixer 412e, a supplier 412f and a sensor 412g.

The first developing roller 412a and the second developing roller 412b include a developing sleeve which can rotate and a developing magnet roll positioned inside the developing sleeve. The first developing roller 412a and the second developing roller 412b are positioned close to the photosensitive drum 413, and convey the developing agent to a developing region near the photosensitive drum 413. Specifically, the first developing roller 412a and the second developing roller 412b rotate in the same rotating direction. The developing agent is passed from the first developing roller 412a on an upstream side to the second developing roller 412b on a downstream side. The developing agent is conveyed to the developing region of each roller. The developing sleeve rotates in a clockwise direction in the diagram. A plurality of magnetic poles that generate a magnetic field are arranged in the developing magnet roll.

The collecting roller 412c1 which collects excess developing agent is provided near the second developing roller 412b. The collecting roller 412c1 also includes a sleeve which can rotate and a magnet roll positioned inside the sleeve. The collecting roller 412c1 is a developing agent holder which holds the developing agent by magnetic force.

The toner collected by the collecting roller 412c1 is supplied to a mixing conveyor 412c3 through a guide member 412c2. Then, the toner is conveyed by the mixing conveyor 412c3, and is returned to the mixer 412e or a storage chamber of the supplier 412f.

The mixer 412e and the supplier 412f are screw members in a spiral shape. The mixer 412e mixes the toner and carrier by rotation and causes triboelectric charging. The supplier 412f is conveyed from the mixer 412e by rotating, and the triboelectric developer is conveyed to the first developing roller 412a. The sensor 412g is positioned near the mixer 412e and detects toner concentration. Based on the detected result of the sensor 412g, the developing agent corresponding to the consumed toner is replenished from a toner replenisher (not shown).

When the developing agent is guided to the first developing roller 412a, due to a magnetic field generated by the developing magnet roll of the first developing roller 412a, a magnetic brush is generated on the outer peripheral surface of the developing sleeve. With this, a layer of the developing agent is formed on the outer peripheral surface of the developing sleeve. By rotating the developing sleeve in a clockwise direction as shown in the diagram, the developing agent is held on the outer peripheral surface of the developing sleeve by the magnetic field, and the developing agent is conveyed to the developing region closest to the photosensitive drum 413. In the developing region, the toner is electrostatically transferred from the developing sleeve of the first developing roller 412a to the electrostatic latent image formed on the surface of the photosensitive drum 413. Some of the developing agent on the developing sleeve of the first developing roller 412a is passed to the second developing roller 412b by the effect of the magnetic field. In the second developing roller 412b, the layer of the developing agent is formed on the developing sleeve similar to the first developing roller 412a, and the developing agent is transferred to the photosensitive drum 413 in the developing region.

As described above, the toner is supplied to the photosensitive drum 413 and the developer 412 visualizes the electrostatic latent image by the toner. The developer 412 includes two rollers which are the first developing roller 412a and the second developing roller 412b. With this, the developing region can be secured and an image with high quality can be formed.

The carrier is not limited, and any commonly used well-known carrier can be used. For example, a binder type carrier or a coat type carrier can be used. The carrier particle size is not limited, and preferably, the size is 15 to 100 μm.

The toner is not limited, and any commonly used well-known toner can be used. For example, a binder resin includes a colorant, and a charge control agent, a mold release agent, or the like is included as necessary. Such binder resin is treated with an external additive. The result is used as the toner. The toner particle size is not limited, and preferably, the size is about 3 to 15 μm.

The drum cleaning device 415 includes a drum cleaning blade which scrapes a surface of the photosensitive drum 413, and removes the transferred toner remaining on the surface of the photosensitive drum 413 after the primary transfer.

The intermediate transfer unit 42 includes an intermediate transfer belt 421, a primary transfer roller 422 (transfer unit), a plurality of support rollers 423, a secondary transfer roller 424, a belt cleaning device 426, a sensor 427 and the like.

The intermediate transfer belt 421 includes an endless belt, and is stretched in a loop on a plurality of support rollers 423. At least one of the plurality of support rollers 423 is a drive roller, and the others are driven rollers. For example, preferably, a roller 423A positioned on a downstream side than a primary transfer roller 422 for a K component in a belt traveling direction is to be a drive roller. With this, it is easier to maintain a constant speed in a running speed of the belt in the primary transfer unit. The intermediate transfer belt 421 runs at a certain speed in a direction of the arrow A according to the rotation by the drive roller 423A.

The primary transfer roller 422 is positioned facing the photosensitive drum 413 of each color component on an inner peripheral surface side of the intermediate transfer belt 421. The primary transfer roller 422 is pressed against the photosensitive drum 413 with the intermediate transfer belt 421 in between. With this, a primary transfer nip in order to transfer the toner image from the photosensitive drum 413 to the intermediate transfer belt 421 is formed.

The secondary transfer roller 424 is positioned facing a roller 423B (hereinafter referred to as “backup roller 423B”) positioned on the downstream side of the drive roller 423 in the belt running direction and is positioned on the outer peripheral surface side of the intermediate transfer belt 421. The secondary transfer roller 424 is pressed against the backup roller 423B with the intermediate transfer belt 421 in between. With this, a secondary transfer nip in order to transfer the toner image from the intermediate transfer belt 421 to the sheet is formed.

When the intermediate transfer belt 421 passes the primary transfer nip, the toner image on the photosensitive drum 413 is sequentially overlapped on the intermediate transfer belt 421 and primary transfer is performed. Specifically, a primary transfer bias is applied to the primary transfer roller 422 and charge with a polarity opposite to the toner is applied on the back surface side of the intermediate transfer belt 421 (side in contact with the primary transfer roller 422). With this, the toner image is electrostatically transferred to the intermediate transfer belt 421.

Then, when the sheet passes the secondary transfer nip, the toner image on the intermediate transfer belt 421 is transferred on the sheet and the secondary transfer is performed. Specifically, the secondary transfer bias is applied to the secondary transfer roller 424 and charge with the polarity opposite to the toner is applied on the back surface side of the sheet (side in contact with the secondary transfer roller 424). With this, the toner image is electrostatically transferred on the sheet. The sheet in which the toner image is transferred is conveyed to the fixer 60.

The belt cleaning device 426 includes a belt cleaning blade which scrapes a surface of the intermediate transfer belt 421, and removes the transferred toner remaining on the surface of the intermediate transfer belt 421 after the secondary transfer. Instead of the secondary transfer roller 424, a configuration in which a secondary transfer belt is stretched in a loop shape on a plurality of support rollers including the secondary transfer roller (so-called belt-type secondary transfer unit) can be employed.

For example, the sensor 427 is provided between the roller 423A and the roller 423B so as to face the surface of the intermediate transfer belt 421, and the amount of toner attached on the intermediate transfer belt 421 is detected. For example, an optical reflection concentration sensor can be used as the sensor 427, and the sensor 427 can be used for control of the image concentration.

After the secondary transfer of the toner image is performed on the sheet and the sheet is conveyed, the fixer 60 applied heat and pressure to the sheet with the fixing nip and fixes the toner image to the sheet.

The sheet conveyor 50 includes a sheet feeder 51, a sheet ejector 52, and a conveying path 53. The sheets identified based on the basis weight or size (standard sheet, special sheet) are accommodated in three sheet feeding tray units 51a to 51c included in the sheet feeder 51. The type to be accommodated in each sheet feeding tray unit is set in advance. The conveying path 53 includes a plurality of conveying roller pairs such as a registration roller pair 53a.

The sheets accommodated in the sheet feeding tray units 51a to 51c are sent out one by one from the top, and the sheet is conveyed to the image former 40 by the conveying path 53. Here, the registration roller unit in which the registration roller pair 53a is provided corrects the tilt in the fed sheet and adjusts the conveying timing. In the image former 40, secondary transfer of the toner image on the intermediate transfer belt 421 is performed collectively on one side of the sheet and the fixing step is performed in the fixer 60. The sheet in which the image is formed is ejected outside the apparatus by the sheet ejector 52 including the sheet ejection roller 52a.

The sheet can be a long sheet or a roll sheet. In this case, the sheet is accommodated in the sheet feeding device (not shown) connected to the image forming apparatus 1, and the sheet held in the sheet feeding device is supplied from the sheet feeding device to the image forming apparatus 1 through the sheet feeding opening 54 and sent out to the conveying path 53.

For example, the storage 70 includes a nonvolatile semiconductor memory (so-called flash memory), hard disk drive, or the like. The storage 70 stores various data such as various setting information regarding the image forming apparatus 1.

For example, the communicator 80 includes a communication control card such as a LAN (Local Area Network) card, etc. and performs transmitting and receiving of various data with external devices (for example, personal computer) connected to the communication network such as the LAN, WAN (Wide Area Network), etc.

[Toner Refresh Control]

Next, the toner refresh control performed by the controller 100 is described.

In addition to the above configuration, a developing current detector 409 (FIG. 2) is provided in the image forming apparatus 1 in order to detect the developing current flowing between the photosensitive drum 413 and the developing rollers 412a and 412b when the developing by the developer 412 is performed.

The controller 100 performs forced toner discharge control by developing a predetermined toner image on the photosensitive drum 413 by the developer 412 and forcibly discharging toner from the developer 412.

When the toner is discharged during the forced toner discharge control, the developing current detector 409 detects the developing current generated by the toner moving from the developer 412 to the photosensitive drum 413, and the value is input in the controller 100.

The controller 100 controls the toner discharge amount according to the forced toner discharge control based on the current value detected by the developing current detector 409. According to the present embodiment, in order to perform the discharge efficiently, the toner discharge amount is controlled depending on the timing that the developing of the image including the solid colored surface starts, and the timing that this ends. The controller 100 determines the end timing based on the current value detected by the developing current detector 409.

For example, the end timing of the toner discharge by the developing of the image including the solid colored surface may be when the toner concentration decreases and the developing current value decreases to a value set in advance from the developing current value at the start of creating the solid colored surface, when the image including the solid colored surface is formed but the developing potential of the electrostatic latent image of the solid colored surface could not be filled due to the decrease in toner concentration and the developing current value changes drastically, or when the toner in the developer 412 is mostly discharged and carrier adhesion occurs. The ratio of exchanging the toner after fresh toner replenishment performed later on and the time necessary to perform the forced toner discharge control changes depending on the setting condition of the discharge end timing. Therefore, the toner discharge end timing is set from the performance required in the apparatus.

The controller 100 controls the toner replenishment in which the toner amount discharged by the forced toner discharge control is replenished in the developer 412 by the toner replenisher. The forced toner discharge control and the toner replenishment control that follows corresponds to one toner refresh control.

Hereinafter, the toner refresh control in the image forming apparatus 1 is described by showing examples.

### Example 1

A running test is performed in an equivalent of 50000 pages in an A4 size with a printing rate of 0.3% coverage. The external additive on the toner surface in the developing agent is released or buried so that a large amount of deteriorated toner in which the normal charge is not obtained, that is, the charge is decreased to be a weak charge or a counter charge is included. When an image sample is taken in such state, halftone which was smooth when confirmed by sight before the test includes rough portions. Also, fog can be clearly confirmed by sight in the background.

### Comparative Example 1

The toner refresh control is performed to create the solid colored surface in order to discharge deteriorated toner. The square area of the solid colored surface is to be the equivalent of five sheets in an A3 size, and then the toner is replenished in the developer 412 by referring to the output value of the toner concentration control sensor 412g.

After such toner refresh control, the roughness of the halftone is improved from the level before control. However, it is still not an allowable level. Further, fog can still be slightly confirmed by sight. Therefore, similar toner refresh control (creating the solid colored surface in an equivalent of five sheets in an A3 size and replenishing the toner) is performed again and the roughness in the halftone and the fog became an acceptable level.

### Present Invention Example 1

According to the present invention example 1, the controller 100 controls the toner discharge amount in the forced toner discharge control based on the current value in the value determined in advance.

The controller 100 performs the toner refresh control in which the solid colored surface is created while monitoring the developing current detected by the developing current detector 409. FIG. 4 is a graph showing a change in the developing current value detected by the developing current detector 409 with relation to the elapsed time of the developing of the solid colored surface according to the present invention example 1.

Each time the developing agent is circulated in the developer 412, the toner is consumed and the toner developing amount decreases. The continuous flat portion in the graph shown in FIG. 4 corresponds to one circulation, and the current value decreases each time the circulation is performed once. Although the current value decreases with each circulation, the charge amount gradually increases as the toner concentration decreases. Therefore, the decrease of the developing current is gradual.

The controller 100 ends the creating of the solid colored surface at a current value I₁ which is a 10% decrease from the current value I₀ when the control of the developing current value is started. Then, the output value of the toner concentration control sensor 412g is referred and the toner replenishment is performed.

The current value I₁ is the value known by an experiment performed in advance and one fourth of the toner amount in the developing agent is discharged.

When the image sample is taken, the roughness in the halftone and the fog is the same level as the comparative example 1 which is performed with the involvement of the operator.

### Example 2

The running test with low coverage is performed similar to example 1 and the state is created so that there is a large amount of deteriorated toner in the developing agent.

### Comparative Example 2

The toner refresh control is performed to create the solid colored surface in order to discharge deteriorated toner. The square area of the solid colored surface for the toner refresh control is to be an equivalent of five sheets in an A3 size for each time the toner refresh control is performed, and then the toner is replenished with reference to the output value of the toner concentration control sensor 412g.

The toner refresh control is repeated with the aim of returning the halftone smoothness and the fog closer to the level before the test more than the comparative example 1. After the toner refresh control is performed six times, the smoothness of the halftone and the fog is close to the state before the test. In order to perform the toner discharge in the toner refresh control at once, the square area is to be the equivalent of 30 sheets in the A3 size, and then the toner is replenished with reference to the output value of the toner concentration control sensor 412g. In this case also, the same result is achieved. However, the toner concentration decreased too much during the forced toner discharge control and it is not possible to notice that the carrier adhesion occurs. Therefore, the developing agent reduced compared to before the test.

The carrier adhesion means that the carrier adhered to the photosensitive drum 413 and the carrier decreased in the developer 412. Therefore, when the toner is replenished to recover the toner concentration, the developing agent reduces in the amount that the carrier reduces.

### Present Invention Example 2

Similar to the present invention example 1, in the present invention example 2, the controller 100 controls the toner discharge amount in the forced toner discharge control based on the current value of the value determined in advance, and the value of the present invention example 1 is changed.

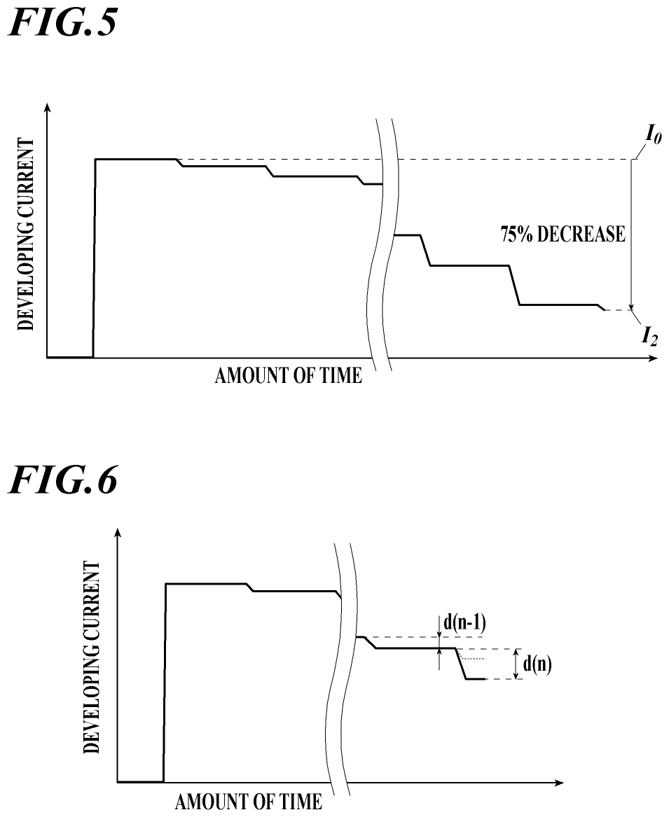

The controller 100 performs the toner refresh control in which the solid colored surface is created while monitoring the developing current detected by the developing current detector 409. FIG. 5 is a graph showing a change of the developing current value detected by the developing current detector 409 with relation to the elapsed time of the developing of the solid colored surface in the present invention example 2.

The controller 100 ends creating the solid colored surface when the developing current value reaches the current value I₂ decreased 75% from the current value I₀ when the control starts. Then, the toner is replenished with reference to the output value of the toner concentration control sensor 412g. The current value I₂ is a value known to discharge four fifths of the toner amount in the developing agent from the experiments performed in advance.

The roughness in the halftone and the fog after the toner refresh control is the same level as the comparative example 2 performed with the operator involved and there is no change in the amount of the developing agent compared to before the test.

### Example 3

A low coverage running test is performed similar to the examples 1 and 2 and the developing agent is prepared to be in a state including a large amount of deteriorated toner.

### Comparative Example 3

Here, the new comparative example is not created and the comparative example 3 is omitted.

### Present Invention Example 3

In the present invention example 3, the controller 100 controls the toner discharge amount in the forced toner discharge control based on the change amount of the current value. Here, the change amount of the current value is to be a decrease amount of the developing agent for one circulation.

The controller 100 performs the toner refresh control in which the solid colored surface is created while monitoring the developing current detected by the developing current detector 409. FIG. 6 is a graph showing a change in the developing current value detected by the developing current detector 409 with relation to the elapsed time of the developing of the solid colored surface in the present invention example 3.

Here, the toner is consumed each time the developing agent circulates in the developer 412 and the toner developing amount decreases. The continuous flat portion in the graph shown in FIG. 6 corresponds to one circulation, and the current value decreases with each circulation. Although the current value decreases with each circulation, the charge amount gradually increases as the toner concentration decreases. Therefore, the decrease of the developing current is gradual. When it is detected that at a certain point a decrease amount d(n) of the developing current from the previous section is decreased two times or more with relation to a decrease amount d(n−1) of a section average value when the developing agent circulated in the developer 412 the previous time and that the developing agent is discharged to a degree that the toner concentration is decreased such that the developing potential of the electrostatic latent image with a solid colored surface cannot be filled, the controller 100 stops creating the solid colored surface. Then, the controller 100 replenishes the toner with reference to the output value of the toner concentration control sensor 412g.

The roughness in the halftone and the fog slightly remained after the toner refresh control. However, the quality is a level that is satisfactory for most users, and there is no change in the developing agent amount compared to before the test. Although the quality after the toner refresh control is slightly lower than the present invention example 2, the control ended within a short amount of time, and it is possible to decrease the risk of the developing agent decreasing by the carrier adhesion due to the reduction in the toner concentration.

### Example 4

A low coverage running test is performed similar to the examples 1 to 3, and the developing agent is prepared to be in a state including a large amount of deteriorated toner.

### Comparative Example 4

The toner refresh control is performed to create the solid colored surface in order to discharge deteriorated toner. The square area of the solid colored surface for the toner refresh control is to be the equivalent of five sheets in an A3 size for each time the toner refresh control is performed, and then the toner is replenished with reference to the output value of the toner concentration control sensor 412g.

The toner refresh control is repeated with the aim of returning the halftone smoothness and the fog to the same level as before the test. After the toner refresh control is performed eight times, the smoothness of the halftone and the fog is the same as the state before the test. In order to perform the discharge of toner during the toner refresh control at once, the square area of the solid colored surface is to be the equivalent of 40 sheets in the A3 size, and then the toner is replenished with reference to the output value of the toner concentration control sensor 412g. In this case also, the same result is achieved. However, the toner concentration decreased too much during the forced toner discharge control and it is not possible to notice that the carrier adhesion occurs. Therefore, the developing agent reduced greatly compared to before the test.

### Present Invention Example 4

In the present invention example 4, the controller 100 controls the toner discharge amount in the forced toner discharge control based on how frequent the pulse exceeds a threshold TH1 determined in advance in the current value detected by the developing current detector 409.

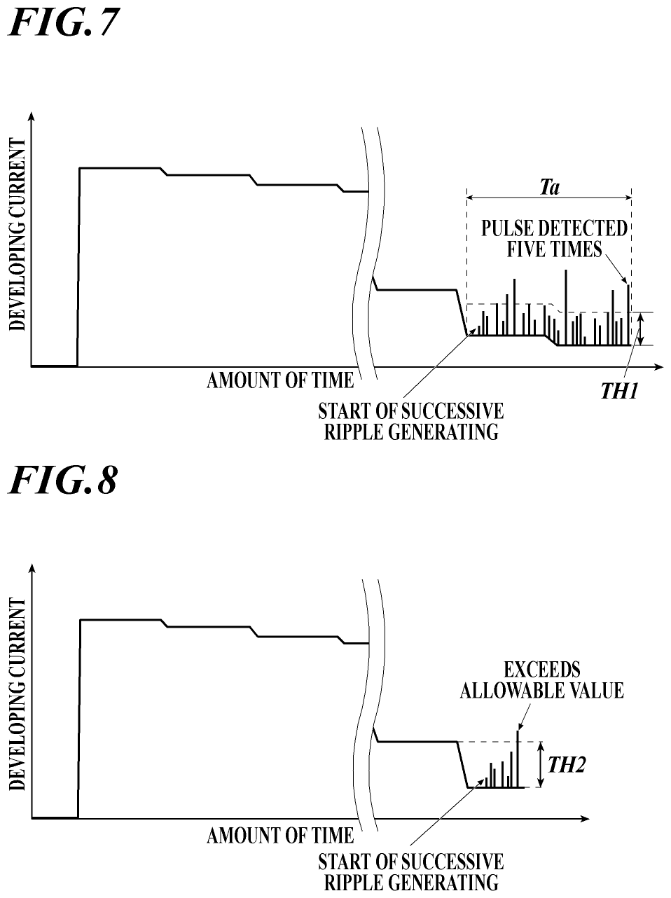

The controller 100 performs the toner refresh control in which the solid colored surface is created while monitoring the developing current detected by the developing current detector 409. FIG. 7 is a graph showing the change in the developing current value detected by the developing current detector 409 with relation to the elapsed time of developing the solid colored surface in the present invention example 4.

In the present invention example 4, the control is continued after the developing current greatly decreases as in the present invention example 3. However, it is detected that at a certain point, the ripple is continuously generated in the developing current, the charge injection occurs in the carrier in the developing agent in which the toner concentration decreases and the resistance decreases, and the carrier with the large size and a large charge amount starts to adhere successively on the photosensitive drum 413.

In order to prevent erroneous detection, duration time Ta in which the developing agent circulates twice in the developer 412 is set as a reference time. Moreover, a pulse threshold TH1 is set to determine the pulse when the size of the ripple exceeds a value determined in advance. When the pulse is detected five times in the standard time Ta, the controller 100 ends creating the solid colored surface. Then, the controller 100 replenishes the toner with reference to the output value of the toner concentration control sensor 412g.

After the toner refresh control is performed, the roughness in the halftone and the fog is the same as the comparative example 4 performed with the operator involved, and there is not much change in the amount of developing agent compared to before the test. This is due to being able to end the creating of the solid colored surface early on at the start of carrier adhesion by detecting the pulse frequency.

### Example 5

A low coverage running test is performed similar to the examples 1 to 4, and the developing agent is prepared to be in a state including a large amount of deteriorated toner.

### Comparative Example 5

Here, the new comparative example is not created and the comparative example 5 is omitted.

### Present Invention Example 5

In the present invention example 5, the controller 100 controls the toner discharge amount in the forced toner discharge control based on the size of the ripple determined in advance in the current value detected by the developing current detector 409.

The controller 100 performs the toner refresh control in which the solid colored surface is created while monitoring the developing current detected by the developing current detector 409. FIG. 8 is a graph showing a change in the developing current value detected by the developing current detector 409 with relation to the elapsed time of the developing of the solid colored surface in the present invention example 5.

In the present invention example 5, similar to the present invention example 4, it is detected that the ripple occurs continuously in the developing current detected by the developing current detector 409, and the carriers start to be adhered successively on the photosensitive drum 413.

In order to prevent erroneous detection, a ripple allowable current value TH2 is set as a value larger than the ripple when a small amount of carrier adheres such as in a single occasion. When it is detected that the ripple exceeds the allowable current value TH2, the controller 100 stops creating the solid color surface. Then, the controller 100 replenishes the toner with reference to the output value of the toner concentration control sensor 412g.

The roughness of the halftone and the fog after the toner refresh control is the same as the comparative example 4, and there is not much change in the amount of developing agent compared to before the test. This is because the creating of the solid colored surface ends early on after the carrier adhesion starts by detecting that the value of the ripple exceeds the allowable value.

### Example 6

The toner bottle in which the classifying step during manufacturing of the toner is not performed as usual and in which a large amount of aggregates are remaining is set in the image forming apparatus 1 and the toner is guided to the developer 412. The running test in an equivalent of 5000 pages in an A4 size with a printing rate of 10% coverage is performed. With this, the developing agent includes a large amount of aggregates of toner as the deteriorated toner. Here, the toner bottle is replaced with the toner bottle created by the normal process. When the image sample is obtained in this state, the aggregates of toner caused a countless number of spots on the halftone image and noticeable fog of toner occurred clearly at a rate of one in every five sheets on the sheet in an A3 size.

### Comparative Example 6

The toner refresh control is performed to create the solid colored surface in order to discharge deteriorated toner. The square area of the solid colored surface for the toner refresh control is to be the equivalent of five sheets in an A3 size for each time the toner refresh control is performed, and then the toner is replenished with reference to the output value of the toner concentration control sensor 412g.

The spots in the halftone after the toner refresh control became about half compared to before the toner refresh control, but this is still unacceptable. The toner spill is still a rate of one in every 20 sheets. Therefore, the toner refresh control is performed again. Then, the spots in the halftone became about 10% compared to before the toner refresh control. The toner spill recovered to a rate of one in every 50 sheets.

### Present Invention Example 6

The controller 100 performs the contents of control similar to the present invention example 1 in the toner refresh control in which the solid colored surface is created while monitoring the developing current detected by the developing current detector 409. The spots of the halftone and the toner spill after the control became the same level as the comparative example 6 which is performed with the operator involved.

### Example 7

Similar to the example 6, the running test is performed with the toner bottle including aggregates, and the developing agent includes a large amount of deteriorated toner.

### Comparative Example 7

The toner refresh control is performed to create the solid colored surface in order to discharge deteriorated toner. The square area of the solid colored surface for the toner refresh control is to be the equivalent of five sheets in an A3 size for each time the toner refresh control is performed, and then the toner is replenished with reference to the output value of the toner concentration control sensor 412g.

The toner refresh control is repeated with the aim of returning the level of the spots in the halftone and the toner spill to the level closer to the level before the test (no spots, toner spill in one sheet in 500 sheets) more than the comparative example 6. After performing the toner refresh control six times, the spots in the halftone became one in A3 size and the toner spill became one sheet in 400 sheets and close to the state before the test. In order to perform the toner discharge in the toner refresh control at once, the square area is to be the equivalent of 30 sheets in the A3 size, and then the toner is replenished with reference to the output value of the toner concentration control sensor 412g. In this case also, the same result is achieved. However, the toner concentration decreased too much during the forced toner discharge control and it is not possible to notice that the carrier adhesion occurs. Therefore, the developing agent reduced greatly.

### Present Invention Example 7

The controller 100 performs the control contents similar to the present invention example 2 in the toner refresh control in which the solid colored surface is created while monitoring the developing current detected by the developing current detector 409. The spots in the halftone and the toner spill after the toner refresh control is the same level as the comparative example 7 which is performed with the operator involved, and the amount of developing agent hardly changed compared to before the test.

### Example 8

Similar to the examples 6 and 7, the running test is performed with the toner bottle including the aggregates, and the developing agent includes a large amount of deteriorated toner.

### Comparative Example 8

Here, the new comparative example is not created and the comparative example 8 is omitted.

### Present Invention Example 8

The controller 100 performs the control contents similar to the present invention example 3 in the toner refresh control in which the solid colored surface is created while monitoring the developing current detected by the developing current detector 409. After the toner refresh control, the spots in the halftone are improved to three in the A3 size, and the toner spill is improved to one sheet out of 300 sheets. There is no change in the developing agent compared to before the test.

Although the quality after control decreased slightly compared to the present invention example 7, the control ended within a short amount of time, and it is possible to decrease the risk of the developing agent decreasing by the carrier adhesion due to the decrease in the toner concentration.

### Example 9

Similar to the embodiments 6 to 8, the running test is performed with the toner bottle including the aggregates, and the developing agent includes a large amount of the deteriorated toner.

### Comparative Example 9

In order to discharge the deteriorated toner, the toner refresh control is performed to create the solid colored surface. The square area of the solid colored surface for the toner refresh control is to be the equivalent of five sheets in an A3 size for each time the toner refresh control is performed, and then the toner is replenished with reference to the output value of the toner concentration control sensor 412g.

The toner refresh control is repeated with the aim of returning the spots in the halftone and the toner spill to the same level as before the test more than the comparative example 7. After performing the toner refresh control eight times, there are no more spots in the halftone, and the toner spill became one in 500 sheets. The level became the same as before the test. In order to perform the toner discharge at once in the toner refresh control, the square area is to be the equivalent of 40 sheets in the A3 size, and then the toner is replenished with reference to the output value of the toner concentration control sensor 412g. In this case also, the same result is achieved. However, the toner concentration decreased too much during the forced toner discharge control and it is not possible to notice that the carrier adhesion occurs. Therefore, the developing agent reduced greatly.

### Present Invention Example 9

The controller 100 performs the control contents similar to the present invention example 4 in the toner refresh control in which the solid colored surface is created while monitoring the developing current detected by the developing current detector 409. After the toner refresh control, the spots in the halftone and the toner spill is the same as the comparative example 9. There is almost no change in the developing agent amount compared to before the test.

### Example 101

Similar to the examples 6 to 9, the running test is performed with the toner bottle including the aggregate and the developing agent includes a large amount of deteriorated toner.

### Comparative Example 10

Here, the new comparative example is not created and the comparative example 10 is omitted.

### Present Invention Example 10

The controller 100 performs the control contents similar to the present invention example 5 in the toner refresh control in which the solid colored surface is created while monitoring the developing current detected by the developing current detector 409. After the toner refresh control, the spots in the halftone and the toner spill is the same level as the comparative example 9, and there is not much change in the amount of the developing agent compared to before the test.

### CONCLUSION

According to the present embodiment as described above, the developing current which is the signal according to the degree of progress of the discharge of the toner is detected, and the toner discharge amount is controlled based on the developing current. With this, the discharge amount of toner when the forced discharge of the deteriorated toner is performed from the developer of the image forming apparatus can be controlled accurately.

Therefore, it is possible to perform effective toner refresh control while preventing the insufficient discharge of deteriorated toner.

Moreover, it is possible to perform efficient toner refresh control while suppressing the excess discharge operation after discharging the deteriorated toner.

Moreover, the controller is able to determine the operation amount of the toner discharge in order to discharge the deteriorated toner without relying on the determination by the operator. Therefore, the toner refresh control can be automated.

Therefore, there is no need to repeat the toner refresh control including the time to wait for the determination of the operator in between. With this, it is possible to obtain an image forming apparatus which executes the toner refresh control automatically with the least amount of time necessary.

The scope of the present invention is not limited to the above-described embodiment, and includes various modifications of the above embodiments within the scope of the claims of the present invention. The conditions of the timing to end the creating of the solid colored surface set in the above embodiments is not limited to the above values, change amount, number of times of detection, etc., and the conditions can be suitably set according to the performance necessary in the apparatus.

According to the present embodiment, the toner discharge amount is controlled by the timing of starting and ending the developing of the solid colored image. Alternatively, the amount of time of developing can be fixed to a certain term, and the toner discharge amount may be controlled depending on the change in the developed tone.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image carrier;
an exposure device which draws an electrostatic latent image on the image carrier;
a developer which uses a developing roller facing the image carrier to supply a developing agent to the electrostatic latent image formed on the image carrier and to develop a toner image;
a developing current detector which detects a developing current flowing between the image carrier and the developing roller during developing by the developer; and
a controller which controls the above,
wherein,
the controller performs forced toner discharge control in which a predetermined toner image is developed on the image carrier by the developer and the toner is forcibly discharged from the developer, and
the controller controls a toner discharge amount in the forced toner discharge control based on a current value detected by the developing current detector.

2. The image forming apparatus according to claim 1, wherein, the controller controls the toner discharge amount in the forced toner discharge control based on the current value determined in advance.

3. The image forming apparatus according to claim 1, wherein, the controller controls the toner discharge amount in the forced toner discharge control based on an amount of change in the current value.

4. The image forming apparatus according to claim 1, wherein, the controller controls the toner discharge amount in the forced toner discharge control based on a frequency of a pulse exceeding a threshold set in advance in the current value.

5. The image forming apparatus according to claim 1, wherein, the controller controls the toner discharge amount in the forced toner discharge control based on a size of a ripple set in advance in the current value.

6. The image forming apparatus according to claim 1, further comprising a toner replenisher which replenishes toner in the developer, wherein,
the controller controls the toner replenisher to replenish in the developer a toner amount of the toner discharged in the forced toner discharge control.
